(19) United States
(12) Patent Application Publication
(10) Pub. No.: US 2014/0042774 A1
(43) Pub. Date: Feb. 13, 2014

(54) FRONT SIDE MEMBER ASSEMBLY AND METHOD OF ASSEMBLING THE SAME

(71) Applicants: HYUNDAI MOTOR COMPANY, Seoul (KR); KIA MOTORS CORPORATION, Seoul (KR)

(72) Inventor: Eun-jung Kim, Seoul (KR)

(73) Assignees: Kia Motors Corporation, Seoul (KR); Hyundai Motor Company, Seoul (KR)

(21) Appl. No.: 13/720,475

(22) Filed: Dec. 19, 2012

(30) Foreign Application Priority Data
Aug. 8, 2012 (KR) 10-2012-0086917

(51) Int. Cl. B62D 21/15

(52) U.S. Cl. CPC B62D 21/152
USPC 296/187.02; 29/897.2; 296/187.09; 296/203.02

(57) ABSTRACT

A front side member assembly includes a front side member body having at least one coupling hole at one surface thereof with a closed section shape, a bulkhead including a coupling portion and expansion foam that may be coupled to the coupling portion, wherein the bulkhead may be inserted into the front side member body in order to position the coupling portion at a position corresponding to the coupling hole, and the expansion foam may be hardened to reinforce rigidity of the front side member body.

### CROSS-REFERENCE TO RELATED APPLICATION

The present application claims priority to Korean Patent Application No. 10-2012-0086917 filed on Aug. 8, 2012, the entire contents of which is incorporated herein for all purposes by this reference.

### BACKGROUND OF THE INVENTION

1. Field of the Invention

The present invention relates to a front side member assembly and a method of assembling the same. More particularly, the present invention relates to a front side member assembly and a method of assembling the same that enhance rigidity of a vehicle body while reducing a weight.

2. Description of Related Art

A front side member is a member that supports a front body and secures strength and rigidity of the front body.

That is, the front side member supports a load that is transferred from a front suspension, and when large impact energy is transferred due to collision of a vehicle, the front side member absorbs the impact energy.

One end of the front side member is generally coupled to a vehicle bumper using a bumper stay as an intermediary.

When a vehicle collides, in order to appropriately absorb impact energy, the front side member should have enough rigidity.

In order to absorb a predetermined level of impact energy, a reinforcement structure may be added to the front side member, for example, a method of directly welding a reinforced member to the outside of the front side member exists, but the method has a drawback that an effect of rigidity reinforcement is weak.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a front side member assembly and a method of assembling the same having advantages of having a light weight and enhancing rigidity of a vehicle body.

In an aspect of the present invention, a front side member assembly may include a front side member body having at least one coupling hole at a surface thereof, with a closed section shape, a bulkhead including a coupling portion and an expansion foam that is coupled to the coupling portion, wherein the bulkhead is inserted into the front side member body to position the coupling portion at a position corresponding to the coupling hole, and wherein the expansion foam is hardened to reinforce rigidity of the front side member body.

The front side member body may have at least one bent portion in a length direction thereof

The front side member assembly may further include an insert that fixes the bulkhead to the front side member body by coupling to the coupling portion through the at least one coupling hole.

The insert is a bolt and the coupling portion is a nut.

A chassis mounting bracket is coupled to the coupling hole through the coupling portion.

The bulkhead may have a clamp hole configured to insert the bulkhead into the front side member body.

The front side member is formed by hydrofoaming.

The front side member body is formed with an inner panel and an outer panel that are coupled to form the closed section shape.

In another aspect of the present invention, a method of assembling a front side member may include forming a bulkhead by coupling a coupling portion and an expansion foam, inserting the bulkhead into a front side member body of a closed section shape in which a coupling hole is formed, fixing the bulkhead to an inside surface of the front side member body, and hardening the expansion foam.

The method may further include mounting a chassis mounting bracket to the front side member body through the coupling portion.

The coupling portion is formed with a nut, and the fixing of the bulkhead may include coupling a bolt to the nut through the coupling hole.

The front side member body is formed by hydrofoaming.

The front side member body is formed with an inner panel and an outer panel that are coupled to form the closed section shape.

In a front side member assembly and a method of assembling the front side member according to an exemplary embodiment of the present invention, the entire front side member can have a light weight and rigidity of a vehicle body can be enhanced.

Further, in a front side member assembly and a method of assembling the front side member according to an exemplary embodiment of the present invention, the number of production processes can decrease, and a production cost can be lowered.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view illustrating a front side member assembly according to an exemplary embodiment of the present invention.

FIG. 2 is a cross-sectional view illustrating the front side member assembly taken along line II-II of FIG. 1.

FIG. 3 is a perspective view illustrating an actual use example of a front side member assembly according to an exemplary embodiment of the present invention.

FIG. 4 is a perspective view illustrating an exemplary variation of a front side member assembly according to an exemplary embodiment of the present invention.

FIG. 5 is a flowchart illustrating a method of assembling a front side member according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

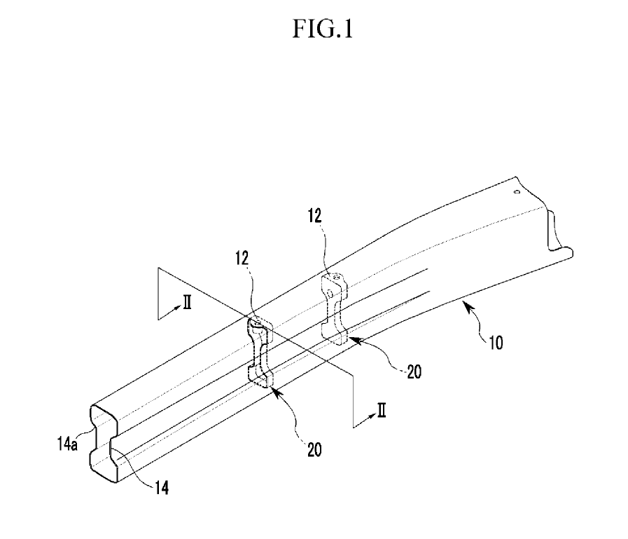

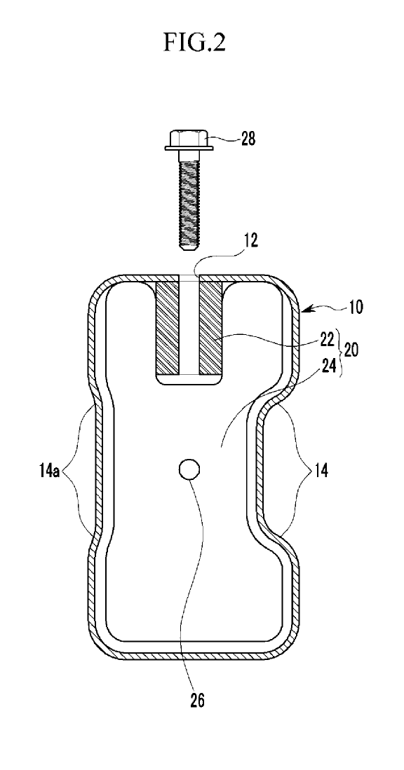

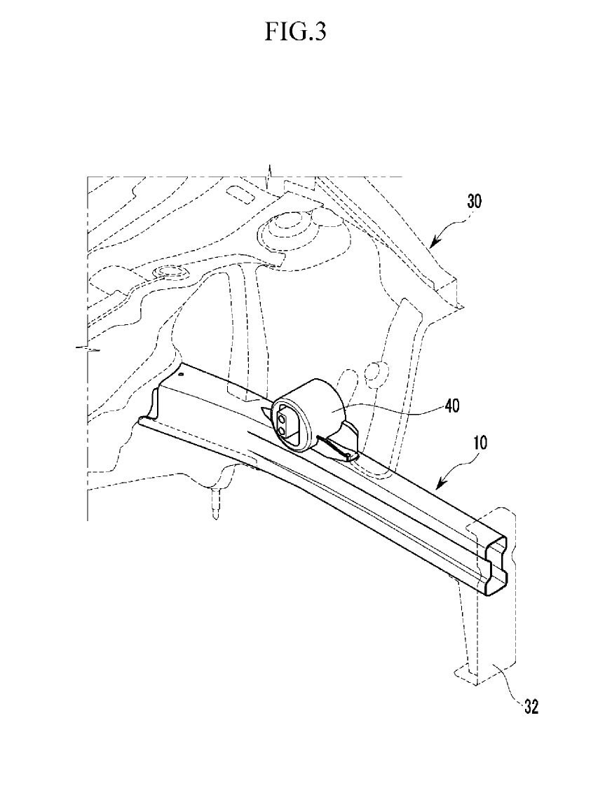

FIG. 1 is a perspective view illustrating a front side member assembly according to an exemplary embodiment of the present invention, FIG. 2 is a cross-sectional view illustrating the front side member assembly taken along line II-II of FIG. 1, and FIG. 3 is a perspective view illustrating an actual use example of a front side member assembly according to an exemplary embodiment of the present invention.

Referring to FIGS. 1 to 3, a front side member assembly according to an exemplary embodiment of the present invention includes a front side member body 10 having a closed section shape and having at least one coupling hole 12 at one surface thereof, and a bulkhead 20 including a coupling portion 22 and an expansion foam 24, i.e., a structure form that is coupled to the coupling portion 22, and the bulkhead is inserted into the front side member body 10 so that the coupling portion 22 positions at a position corresponding to the coupling hole 12 and the expansion foam 24 is hardened to reinforce rigidity of the front side member body 10.

In a state in which the expansion foam 24 is coupled to the coupling portion 22, the expansion foam 24 inserts the bulkhead 20 into the front side member body 10 during expansion or before expansion. The expansion foam 24 and the coupling portion 22 are coupled using a method such as molding and insert injection.

Referring to FIG. 2, the front side member assembly according to an exemplary embodiment of the present invention further includes an insert 28 that fixes the bulkhead 20 to the front side member body 10 by coupling to the coupling portion 22 through the coupling hole 12.

The insert 28 may be a bolt, and the coupling portion 22 may be a nut.

Referring to FIG. 3, a chassis mounting bracket 40 may be coupled to the front side member body 10 through the coupling hole 12 and the coupling portion 22. Here, the chassis mounting bracket 40 includes a bushing or a bumper stay 32 that connects other parts of a vehicle.

In an exemplary embodiment of the present invention, the coupling portion 22 fixes the bulkhead 20 to the front side member body 10 by positioning the bulkhead 20 at a position corresponding to the coupling hole 12, coupling the insert 28 to the coupling portion 22 through the coupling hole 12, and fixing the bulkhead 20 to the front side member body 10. Thereafter, the expansion foam 24 is hardened to close contact with the front side member body 10 and to be fixed to the front side member body 10.

Here, the expansion foam 24 is hardened with a method that inserts the front side member body 10 or a vehicle body that is coupled to the front side member body 10 into an oven.

Referring again to FIG. 2, at least one bent portions 14 and 14a are formed in a length direction of the front side member body 10. The bent portions 14 and 14a reinforces rigidity of the front side member body 10.

A clamp hole 26 for inserting the bulkhead 20 into the front side member body 10 is formed in the bulkhead 20. By connecting a rod to the clamp hole 26, the bulkhead 20 is inserted into the front side member body 10.

The front side member 10 may be formed by hydrofoaming. Therefore, the front side member 10 and the bulkhead 20 maintain continuity of a closed section thereof by a hydrofoaming process, thereby enhancing rigidity.

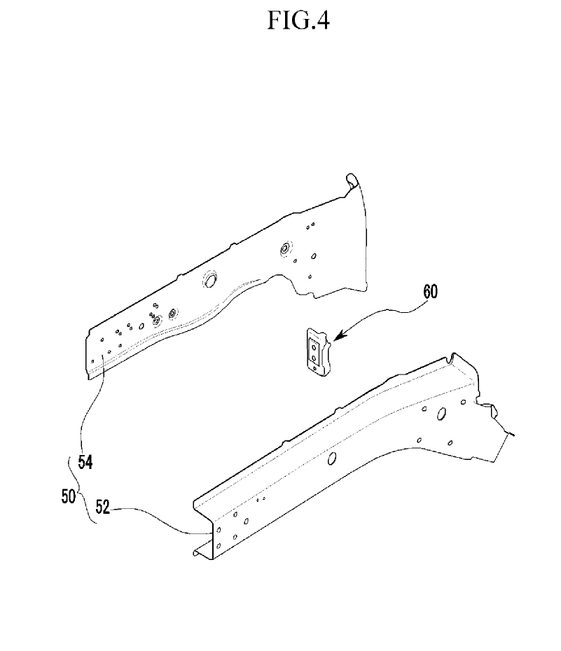

FIG. 4 is a perspective view illustrating an exemplary variation of a front side member assembly according to an exemplary embodiment of the present invention.

Referring to FIG. 4, in a front side member assembly according to an exemplary variation of the present invention, a front side member body 50 is formed when an inner panel 52 and an outer panel 54 are coupled to form a closed section. The front side member assembly according to an exemplary variation of the present invention can be applied to the front side member body 50 that is formed with a welding method, and by inserting a bulkhead 60 into the front side member body 50, rigidity of the front side member body 50 can be reinforced.

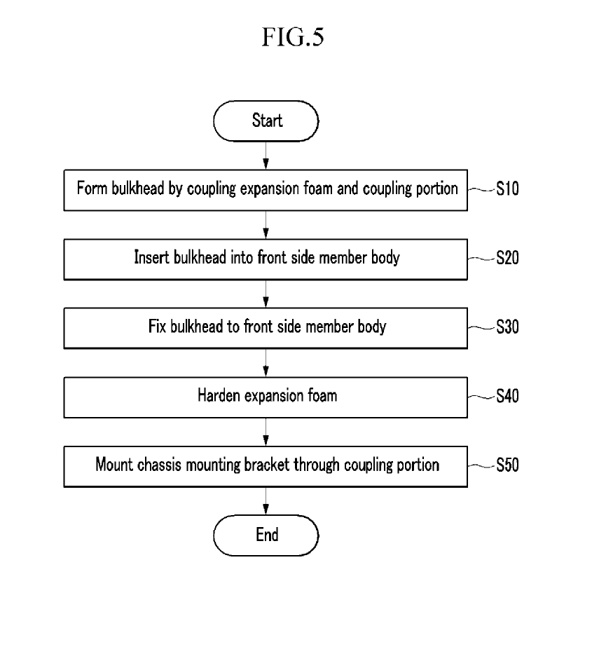

FIG. 5 is a flowchart illustrating a method of assembling a front side member according to an exemplary embodiment of the present invention.

Referring to FIGS. 1, 2, 3, and 5, a method of assembling a front side member according to an exemplary embodiment of the present invention includes step of forming the bulkhead 20 by coupling the coupling portion 22 and the expansion foam 24 (S10), step of inserting the bulkhead 20 into the front side member body 10 of a closed section shape in which the coupling hole 12 is formed (S20), step of fixing the bulkhead 20 to the front side member body 10 (S30), and step of hardening the expansion foam 24 (S40).

The method of assembling a front side member according to an exemplary embodiment of the present invention further includes step of mounting the chassis mounting bracket 40 through the coupling portion 22 (S50).

As the expansion foam 24 is hardened, when the bulkhead 20 and the front side member body 10 are completely fixed, the insert 28 may be separated from the coupling portion 22, and the chassis mounting bracket 40 or the bumper stay 32 may be coupled to the coupling portion 22. In such a case, because a separate member for coupling the chassis mounting bracket 40 or welding processing step may be omitted, the number of production processes and a production cost can be lowered.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A front side member assembly, comprising:
a front side member body having at least one coupling hole at a surface thereof, with a closed section shape;
a bulkhead including a coupling portion and an expansion foam that is coupled to the coupling portion,
wherein the bulkhead is inserted into the front side member body to position the coupling portion at a position corresponding to the coupling hole, and
wherein the expansion foam is hardened to reinforce rigidity of the front side member body.

2. The front side member assembly of claim 1, wherein the front side member body has at least one bent portion in a length direction thereof.

3. The front side member assembly of claim 1, further including an insert that fixes the bulkhead to the front side member body by coupling to the coupling portion through the at least one coupling hole.

4. The front side member assembly of claim 3, wherein the insert is a bolt and the coupling portion is a nut.

5. The front side member assembly of claim 1, wherein a chassis mounting bracket is coupled to the coupling hole through the coupling portion.

6. The front side member assembly of claim 1, wherein the bulkhead has a clamp hole configured to insert the bulkhead into the front side member body.

7. The front side member assembly of claim 1, wherein the front side member is formed by hydrofoaming.

8. The front side member assembly of claim 1, wherein the front side member body is formed with an inner panel and an outer panel that are coupled to form the closed section shape.

9. A method of assembling a front side member, the method comprising:
forming a bulkhead by coupling a coupling portion and an expansion foam;
inserting the bulkhead into a front side member body of a closed section shape in which a coupling hole is formed;
fixing the bulkhead to an inside surface of the front side member body; and
hardening the expansion foam.

10. The method of claim 9, further including mounting a chassis mounting bracket to the front side member body through the coupling portion.

11. The method of claim 9,
wherein the coupling portion is formed with a nut, and
wherein the fixing of the bulkhead includes coupling a bolt to the nut through the coupling hole.

12. The method of claim 9, wherein the front side member body is formed by hydrofoaming.

13. The method of claim 9, wherein the front side member body is formed with an inner panel and an outer panel that are coupled to form the closed section shape.
